(19) United States
(12) Patent Application Publication
(10) Pub. No.: US 2006/0034494 A1
(43) Pub. Date: Feb. 16, 2006

(54) Personal identity data management

(75) Inventor: Robert W. Holloran, Ocala, FL (US)

Correspondence Address: Douglas Wm. Massinger, Esquire;MASSINGER LAW OFFICES, 887 N.W. 100 Street, Ocala, FL, 34479, US

(73) Assignee: NATIONAL BACKGROUND DATA, LLC

(21) Appl. No.: 11/202,551

(22) Filed: Aug. 11, 2005

Related U.S. Application Data
(60) Provisional application No. 60/600,494, filed on Aug. 11, 2004.

(51) Int. Cl. G06K 9/00

(52) U.S. Cl. 382/116

(57) ABSTRACT

Systems, methods and apparatus for personal identity data management permit individuals to manage their criminal background, credit history, employment, demographic and educational information, for example, to establish their credentials and to help protect their good names. All access to this personal identity data, including the biometrics that uniquely establish the individuals' identity, is under the personal control of the individuals, with access limited to others only with their specific authorization. The subject systems, methods and apparatus include at least two separate archives that store encrypted data about individuals that can be accessed only via the individuals' biometrics specific to the archives and unique Identification Numbers. The Identification Numbers are encrypted when they are associated with the individuals' demographic data, which includes their names, Social Security Numbers and the Unique Identifiers assigned by the system to each of the individuals. Public/private key encryption is used to encrypt the Personal Identity Data maintained in the archives and the Identification Numbers maintained in a Personal Identity Management Service configuration application server that links the rest of the system to the archives. To permit the private keys to be securely retained for use in regenerating a. Smartcard in case of loss or damage, separate segments of the private key are stored on different servers each of which requires submittal of a different biometric, which must match the biometric associated with the private key segment.

### CROSS REFERENCE TO RELATED APPLICATION

This application claims the benefit of U.S. Provisional Patent Application number 60/600,494 filed on Aug. 11, 2004 entitled Authenticating, Protecting And Controlling Access To Personal Identity Information.

### FIELD OF THE INVENTION

The subject invention relates to the management of personal identity information in general, and to systems, methods and apparatus for the collection, storage, authentication and protection of, and the controlled access to, personal identity information in particular.

### BACKGROUND OF THE INVENTION

The subject invention embraces the premise that the vast majority of people want to be known as “good apples”. They want the organizations and people with whom they interact, including banks, employers and vendors for instance, to feel confident that they are upstanding (albeit sometimes imperfect) citizens. These “good apples” are willing to expend time and money to document their bona fides, or credentials.

Heretofore, the various organizations with whom individuals interact were responsible for obtaining the individual's personal information data such as, for instance, criminal history background information, credit history information, educational and/or employment history information, from multiple sources. Such an “Organization Centric Model” necessarily involves considerable expense and inconvenience to the organization to obtain the desired information and validate its accuracy.

The “Individual Centric Model” contemplated by the subject invention provides greater flexibility for end-users who can rely on trusted, independent third parties to authenticate the individuals' personal identity data and, through the use of biometric data, validate that the information actually applies to the individuals. In order to provide a complete picture of who they are, the individuals themselves will have the ability, through personal identity management services, to: (1) verify that their records are complete and correct, (2) initiate actions to have their records corrected by repositories for their data, or otherwise challenge the record contents, (3) authorize inclusion of specific records in their Personal Identity Data Archives (“PIDAs”), and (4) control all access to the data in their PIDAs by third parties. As alluded to above, their PIDAs can include all of the personal identity data that constitutes their identity, not just their criminal history records.

Systems, methods and apparatus are needed to support an individual centric model for managing and permitting access to personal identity data. These processes must ensure that individuals have complete control over the release and use of their personal identity data, including their biometrics. In addition, the processes must also protect the integrity of data provided or authenticated by third parties, such as the results of fingerprint-based criminal history background checks.

### SUMMARY OF THE INVENTION.

The subject invention relates to means for individuals to manage their personal identity data, to establish their credentials, and to help them protect their good names, including clearing them in the event of identity theft. All access to this personal identity data, including the biometrics that uniquely establish their identity, is under the personal control of the individuals, with access limited to others only with their specific authorization.

In a preferred embodiment, the above objectives and others are implemented through the following primary processes: 1) establishing authentication relationships between a Personal Identity Management Service provider (“PIMS”) and a Personal Identity Data Repository whereby each can ensure that reports concerning an individual's personal identity information provided by the Repository to the PIMS are authentic and changes to the reports detected through the sharing of public digital signature keys and hashing functions; 2) the individual establishing their own PIDA by capturing their fingerprints, photograph and retinal scan, for instance, at a Biometric Capture Services Provider (“BCSP”) and requesting an initial fingerprint-based criminal history background check; 3) the PIMS provider processing the individual's request for an Individual Right of Access criminal history background check of the state and FBI repositories and name-based check of private sector criminal history databases; 4) the individual reviewing the results of said criminal history background checks for accuracy and completeness and taking action to correct erroneous and incomplete information; 5) the individual adding criminal history background check results to their PIDAs; 6) the individual authorizing the release of their criminal history background check results from their PIDA to at least one end-user such as a volunteer organization or employer; 7) the at least one end-user accessing background check results released to it; and then validating that the results were based upon the fingerprints of the individual by: (a) capturing validation fingerprints from the individual or (b) viewing the photograph taken when the fingerprints were captured; 8) the individual requesting other types of personal identity data to be submitted to their PIDA by their PIMS and the applicable data repositories; 9) the individual reviewing other types of personal identity data submitted to their PIDA for accuracy and completeness and taking action to correct erroneous and incomplete information; 10) the individual adding other types of personal identity information to their PIDA; 11) the individual authorizing the release of other types of their personal identity data in their PIDAs to at least one end-user, after confirming that the data is complete and accurate; 12) the at least one end-user accessing said other types of personal identity data released to it; 13) the individual retrieving their PIDA access code based upon the Biometric Capture Service Provider's submittal of fingerprint and retinal scan confirmation of the individual's identity; and 14) the individual optionally requesting additional Individual Right of Access criminal history background checks of the state and FBI repositories and name-based checks of private sector criminal history databases.

There has thus been outlined, rather broadly, the more important features of the invention in order that the detailed description thereof that follows may be better understood, and in order that the present contribution to the art may be better appreciated. There are, of course, additional features of the invention that will be described hereinafter. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting. As such, those skilled in the art will appreciate that the conception, upon which this disclosure is based, may readily be utilized as a basis for the designing of other structures, methods and systems for carrying out the several purposes of the present invention. It is important, therefore, that this disclosure be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are not familiar with patent or legal terms or phraseology, to determine quickly from a cursory inspection the nature and essence of the technical disclosure of the application. The abstract is neither intended to define the invention of the application, nor is it intended to be limiting as to the scope of the invention in any way.

It is, therefore, a primary object of the subject invention to provide systems, methods and apparatus for personal identity information management that provide a means for ensuring that individuals' archived fingerprints cannot be searched in conjunction with criminal justice investigations.

It is also a primary object of the subject invention to provide systems, methods and apparatus for personal identity information management that provide a means for ensuring that data repositories and personal identity management services can submit authenticated personal identity data confidentially and electronically to the individuals' PIDAs.

It is another primary object of the subject invention to provide systems, methods and apparatus for personal identity information management that provide a means for ensuring that individuals can check their personal identity data, which is provided, gathered or authenticated by third-party sources (criminal history record repositories, credit bureaus, personal identity management systems, etc), for accuracy and completeness prior to authorizing the addition of the data to their personal identity data archives.

It is a further primary object of the subject invention to provide systems, methods and apparatus for personal identity information management that provide a means for ensuring that no one, including the individuals, can alter authenticated personal identity data saved in individuals' personal archives, so the data will be credible to recipient organizations.

Still another primary object of the subject systems, methods and apparatus for personal identity information management is to provide a means for ensuring that individuals' personal identity data, including links between the individuals' identity data and their fingerprints, is maintained securely in their personal archives.

Another primary object of the subject systems, methods and apparatus for personal identity information management is to provide a means for ensuring that individuals' personal identity data can be disclosed only as authorized by the individuals to personally accountable representatives of intended recipient organizations and the data is communicated securely to the intended recipients.

Yet another primary object of the subject systems, methods and apparatus for personal identity information management is to provide a means for ensuring that individuals can retrieve their access codes, using two separate types of biometrics to authenticate their identity and that the access codes cannot be retrieved in any other way, including by the system administrators.

These together with other objects of the invention, along with the various features of novelty which characterize the invention, are pointed out with particularity in the claims annexed to and forming a part of this disclosure. For a better understanding of the invention, its advantages and the specific objects attained by its uses, reference should be had to the accompanying descriptive matter in which there is disclosed preferred embodiments of the invention.

### BRIEF DESCRIPTION OF THE DRAWINGS

FIG. 1a is a diagram illustrating the means by which a Personal Information Management Service authenticates personal information data from a Personal Information Data Repository in accordance with a preferred embodiment of the subject invention;

FIG. 1b is a diagram illustrating the means by which a Personal Information Management Service authenticates personal information data decrypted after retrieval from a Personal Information Data Repository in accordance with a preferred embodiment of the subject invention;

FIG. 2 is a diagram illustrating the means by which individuals establish their Personal Identity Data Archives in accordance with a preferred embodiment of the subject invention;

FIG. 3 is a diagram illustrating the means by which a Personal Information Management Service processes requests for individual Right of Access criminal history background checks in accordance with a preferred embodiment of the subject invention;

FIG. 4 is a diagram illustrating the means by which individuals review their criminal history background check results in accordance with a preferred embodiment of the subject invention;

FIG. 5a is a diagram illustrating the means by which individuals add fingerprint-based criminal history background check results to their Personal Identity Data Archives in accordance with a preferred embodiment of the subject invention;

FIG. 5b is a diagram illustrating the means by which individuals add name-based criminal history background check results to their Personal Identity Data Archives in accordance with a preferred embodiment of the subject invention;

FIG. 6 is a diagram illustrating the means by which individuals authorize the release of their fingerprint-based criminal history background checks from their Personal Identity Data Archives in accordance with a preferred embodiment of the subject invention;

FIG. 7 is a diagram illustrating the means by which end-users access fingerprint-based criminal history background checks from individuals' Personal Identity Data Archives in accordance with a preferred embodiment of the subject invention;

FIG. 8 is a diagram illustrating the means by which individuals request other types of personal identity data to be submitted to their Personal Identity Data Archives in accordance with a preferred embodiment of the subject invention;

FIG. 9 is a diagram illustrating the means by which individuals review other types of personal identity data submitted to their Personal Identity Data Archives in accordance with a preferred embodiment of the subject invention;

FIG. 10 is a diagram illustrating the means by which individuals add other types of personal identity information to their Personal Identity Data Archives in accordance with a preferred embodiment of the subject invention;

FIG. 11 is a diagram illustrating the means by which individuals authorize the release of other types of personal identity information to their Personal Identity Data Archives in accordance with a preferred embodiment of the subject invention;

FIG. 12 is a diagram illustrating the means by which authorized end-users access other types of personal identity data released to them in accordance with a preferred embodiment of the subject invention;

FIG. 13 is a diagram illustrating the means by which individuals retrieve their Personal Identity Data Archive codes in accordance with a preferred embodiment of the subject invention; and

FIG. 14 is a diagram illustrating the means by which individuals request additional individual Right of Access criminal history background checks in accordance with a preferred embodiment of the subject invention.

### DETAILED DESCRIPTION OF THE INVENTION

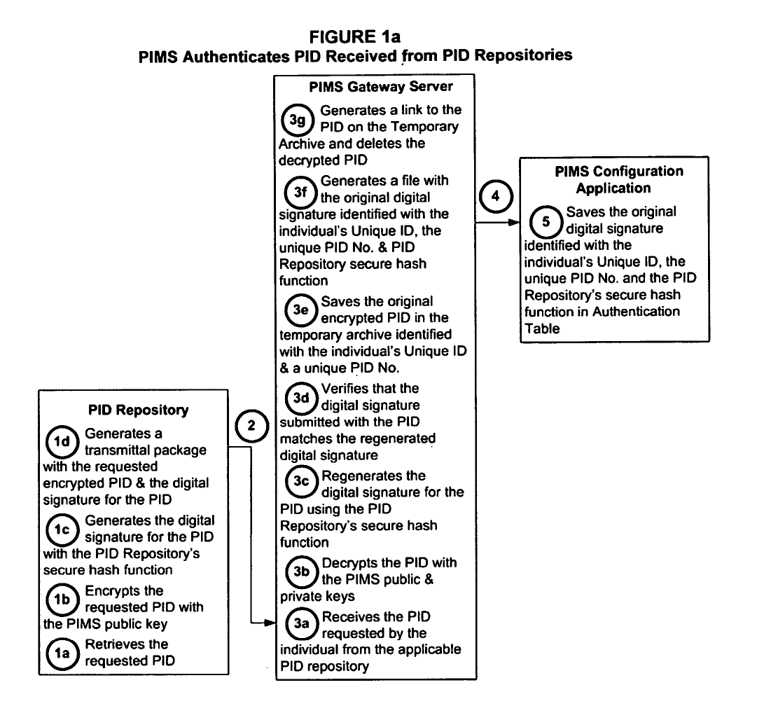

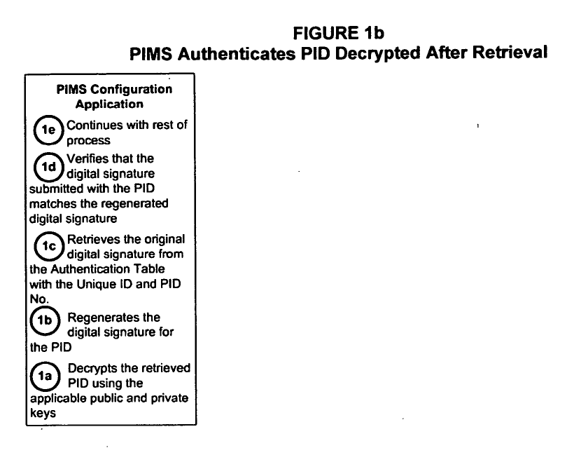

The subject systems, methods and apparatus for personal identity data management are comprised of fourteen primary processes illustrated in FIGS. 1-14 above and described in detail with the corresponding text and Tables below.

With attention first being directed to FIGS. 1a and 1b, a first primary process and components of the subject invention are described, namely a Personal Information Management Service provider (“PIMS”) authenticates Personal Identity Data (“PID”) received from at least one PID Repository. Conventional digital signature technology is used to ensure that data received from PID Repositories (for example, state and federal criminal history repositories, credit bureaus, educational institutions, etc.) has not been altered during transport from the PID Repository or while it is being retained at the PIMS, or Third-Party AFIS, in the case of fingerprint-based criminal history background investigation. In a preferred embodiment the PIMS is able to establish an authentication relationship with the PID Repositories by providing them with a PIMS public key and the PID Repositories provide the PIMS with the secure hash functions they use to create the digital signatures for the PID they transmit to the PIMS. To provide the PlDD Repositories with assurance that the requests submitted by the PIMS on behalf of the individuals have not been altered during transmission, the PID Repositories provide the PIMS their public keys and the PIMS provides them with the secure hash functions it will use to create the digital signatures to authenticate the requests for PID they submit to the PID Repositories.

As shown in FIG. 1a, the PID Repositories respond to the PIMS requests for PID by retrieving the PID, encrypting it with the PIMS public key and then using their secure hash functions to create digital signatures of the PID. They transmit both the encrypted PID and digital signatures to the PIMS.

Upon receipt of the encrypted PID, the PIMS Authentication Server first decrypts it with the PIMS public and private keys. To authenticate that the PID has not been altered during transmission from the PID Repository, the PIMS Authentication Server uses the applicable PID Repository's secure hash function to replicate the digital signature that was transmitted with the PID.

Having authenticated that the PID was not altered since it left the PID Repository, the PIMS saves the encrypted PID in its Temporary Gateway Archive with links to the individual's Unique ID and a unique Data ID that links the encrypted PID to its digital signature that is retained in the PIMS Configuration Application Server's authentication table.

As shown in FIG. 1b, at any point in the subsequent processes when PID is decrypted with the private key of the PIMS, the individual or the End-User, as applicable, is re-authenticated following the decryption to verify that it has not been altered while in storage or in the decryption process. For simplicity, this re-authentication process is not shown in the subsequent flowcharts and process descriptions.

Since some PID Repositories may not be set up to provide their data with digital signatures, a preferred embodiment includes provisions for encrypting PID upon receipt from the PID Repositories with the PIMS public key, at which time a PIMS digital signature is applied. The encrypted PID is subsequently processed as described above. For the purpose of more fully describing the steps which comprise the first primary process, reference is now made to Tables 1A and 1B, below, where each enumerated step corresponds with the inscribed reference numerals of FIGS. 1A and 1B.

TABLE 1A

| | |
|---|---|
| (1a) | The PID Repository retrieves the requested PID. |
| (1b) | The PID Repository encrypts the requested PID with the PIMS public key. |
| (1c) | The PID Repository generates the digital signature for the PID with the PID |
| | Repository's secure hash function. |
| (1d) | The PID Repository generates a transmittal package with the requested PID & the |
| | digital signature for the PID. |
| (2) | The PID Repository sends the transmittal package to the PIMS Gateway Server. |
| (3a) | The PIMS Gateway Server receives the PID requested by the individual from the |
| | applicable PID Repository. |
| (3b) | The PIMS Gateway Server decrypts the PID with the PIMS public and private keys. |
| (3c) | The PIMS Gateway Server regenerates the digital signature for the PID using the PID |
| | Repository's secure hash function. |
| (3d) | The PIMS Gateway Server verifies that the digital signature submitted with the PID |
| | matches the regenerated digital signature. |
| (3e) | The PIMS Gateway Server saves the original encrypted PID within the temporary |
| | archive identified with the individual's Unique ID and a unique PID No. |
| (3f) | The PIMS Gateway Server generates a file with the original digital signature identified |
| | with the individual's Unique ID, the unique PID No. & PID Repository secure hash |
| | function. |
| (3g) | The PIMS Gateway Server generates a link to the PID on the Temporary Archive and |
| | deletes the decrypted PID. |
| (4) | The PIMS Gateway Server sends the file with the original digital signature identified |
| | with the individual's Unique ID, the unique PID No. & PID Repository secure hash |
| | function to the PIMS Configuration Application. |
| (5) | Saves the original digital signature identified with the individual's Unique ID, the unique |
| | PID No. and the PID Repository's secure hash function in Authentication Table. |

TABLE 1B

| | |
|---|---|
| (1a) | The PIMS Configuration Application decrypts the retrieved |
| | PID using the applicable public and private keys. |
| (1b) | The PIMS Configuration Application regenerates the digital |
| | signature for the PID. |
| (1c) | The PIMS Configuration Application retrieves the original digital |
| | signature from the Authentication Table with the Unique ID and |
| | PID No. |
| (1d) | The PIMS Configuration Application verifies that the digital |
| | signature submitted with the PID matches the regenerated digital |
| | signature. |
| (1e) | The PIMS Configuration Application continues with the rest of |
| | the process. |

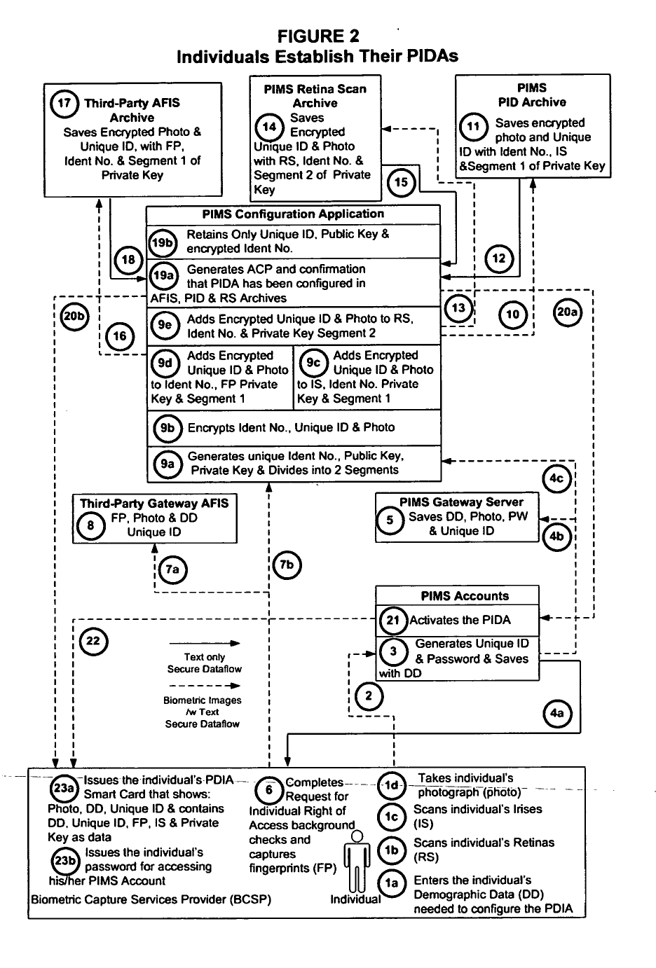

Referring now to FIG. 2, a second primary process of the subject invention is illustrated in diagrammatic form, namely individuals establishing their Personal Identity Data Archive (“PIDA”). The apparatus relies on at least two separate archives that store encrypted data about individuals that can be accessed only via the individuals' biometrics specific to the archives and unique Identification Numbers (“Ident No.”). The Ident Nos. are encrypted when they are associated with the individuals' demographic data (“DD”), which includes their names, Social Security numbers and the Unique Identifiers (“Unique ID”) assigned by the system to each of the individuals. Public/private key encryption is used to encrypt the DD and Personal Identity Data (PID) maintained in the archives and the Ident Nos. maintained in the PIMS Configuration Application server that links the rest of the system to the archives. To establish individuals' PIDAs the PIMS Configuration Application generates: (1) the individuals' Ident Nos., (2) the public keys used to encrypt and decrypt their data, and (3) the private keys that are required to decrypt their data. To permit recovery of the individuals' private keys in the event they are lost, the Configuration Application segments the private keys and saves one segment on each of two separate archives. Since only a portion of the private keys are maintained on each archive, the archives do not include sufficient information to decrypt the PID saved on them. Since only the public key is maintained on the Configuration Application server, the individuals must provide their private keys saved on the Smartcards for use by the Application to decrypt the Ident Nos. in order to access data on the archive servers and to decrypt the data retrieved from them. For the purpose of more fully describing the steps which comprise the second primary process, reference is now made to Table 2, below, where each enumerated step corresponds with the inscribed reference numerals of FIG. 2.

TABLE 2

| | |
|---|---|
| (1a) | The Biometric Capture Services Provider (BCSP) collects the individual's Demographic |
| | Data (DD) required to configure his/her Personal Identity Data Archive (PIDA) Account. |
| (1b) | The BCSP scans the individual's retinas. |
| (1c) | The BCSP scans the individual's irises. |
| (1d) | The BCSP takes the individual's photograph. |
| (2) | The BCSP sends the individual's photo, retina scans and his/her DD to the PIMS |
| | Accounts server. |
| (3) | The PIMS Accounts server generates a Unique ID for the individual's PIDA and password |
| | for accessing the PIMS Gateway and Accounts servers. |
| (4a) | The PIMS Accounts server returns the individual's Unique ID to the BCSP. |
| (4b) | The PIMS Accounts server sends the individual's DD and Unique ID to the PIMS |
| | Gateway Server. |
| (4c) | The PIMS Accounts server sends the individual's photo, retinal scans, DD and Unique ID |
| | to the PIMS Configuration Application Server. |
| (5) | The PIMS Gateway Server saves the individual's DD, PW and Unique ID in its Individuals |
| | Table. |
| (6) | The BCSP captures the individuals' fingerprints using a livescan device. |
| (7a) | The BCSP sends the fingerprints, photo, DD and Unique ID to the Third-Party Gateway |
| | AFIS. |
| (7b) | The BCSP sends the fingerprints, photo, DD and Unique ID to the PIMS Configuration |
| | Application server. |
| (8) | The Third-Party Gateway AFIS temporarily saves the individual's fingerprints, photo, DD |
| | and Unique ID awaiting fingerprint-based background check orders. |
| (9a) | The PIMS Configuration Application server generates a unique Ident No., Public Key, |
| | Private Key, which it divides into Segment 1 and Segment 2 (both of which are required |
| | for the Private Key to function). |
| (9b) | The PIMS Configuration Application server uses the Public Key to encrypt the Ident No., |
| | Unique ID and photo. |
| (9c) | The PIMS Configuration Application server generates a record that includes the Ident |
| | No., Segment 1 of the Private Key, the IS, and the encrypted photo and Unique ID. |
| (9d) | The PIMS Configuration Application server generates a record that includes the Ident |
| | No., Segment 1 of the Private Key, the FP, and the encrypted photo and Unique ID. |
| (9e) | The PIMS Configuration Application server generates a record that includes the Ident |
| | No., Segment 2 of the Private Key, the RS, and the encrypted photo and Unique ID. |
| (10) | The PIMS Configuration Application server sends the record that includes the Ident No., |
| | Segment 1 of the Private Key, the IS, and the encrypted photo and Unique, ID to the |
| | PIMS PID Archive. |
| (11) | The PIMS PID Archive verifies that an account has not been configured for the individual |
| | with the submitted IS and then saves only the Ident No., Segment 1 of the Private Key |
| | and the IS. |
| (12) | The PIMS PID Archive sends confirmation that the individual's PIDA has been configured |
| | or reports that a PIDA has already been configured with the individual's IS. |
| (13) | The PIMS Configuration Application server sends the record that includes the Ident No., |
| | Segment 2 of the Private Key, the RS, and the encrypted photo and Unique ID to the |
| | PIMS Retina Scan Archive. |
| (14) | The PIMS Retina Scan Archive verifies that an account has not been configured for the |
| | individual with the submitted RS and then saves only the Ident No., Segment 2 of the |
| | Private Key and the RS. |
| (15) | The PIMS Retina Scan Archive sends confirmation that the individual's PIDA has been |
| | configured or reports that a PIDA has already been configured with the individual's RS. |
| (16) | The PIMS Configuration Application server sends the record that includes the Ident No., |
| | Segment 1 of the Private Key, the FP, and the encrypted photo and Unique ID to the |
| | Third-Party AFIS Archive. |
| (17) | The Third-Party AFIS Archive verifies that an account has not been configured for the |
| | individual with the submitted FP and then saves only the Ident No., Segment 1 of the |
| | Private Key and the FP. |
| (18) | The Third-Party AFIS Archive sends confirmation that the individual's PIDA has been |
| | configured or reports that a PIDA has already been configured with the individual's FP. |
| (19a) | The PIMS Configuration Application server generates an Account Configuration Package |
| | that includes the Ident No., FP, IS, Private Key and the Unique ID. |
| (19b) | The PIMS Configuration Application server retains the individual's encrypted Ident No., |
| | the Unique ID and Public Key and deletes all other information about the individual's |
| | PIDA. |
| (20a) | The PIMS Configuration Application server sends the PIMS Accounts server confirmation |
| | that the individual's PIDA has been configured with the submitted Unique ID. |
| (20b) | The PIMS Configuration Application server sends the ACP to BCSP. |
| (21) | The PIMS Accounts server activates the individual's PIDA. |
| (22) | The PIMS Accounts server notifies the BCSP that the individual's PIDA has been |
| | configured. |
| (23a) | The BCSP's system verifies that the Unique ID in the ACP matches the Unique ID |
| | returned by the PIMS Accounts Server and issues the individual's PIDA Smartcard that |
| | shows the individual's photo, Unique ID and DD and includes the Unique ID and Private |
| | Key on the Smartcard in a manner that requires fingerprint or iris scan validation to |
| | access. |
| (23b) | The BCSP's system issues the individual's PW for accessing his/her PIMS Account. |

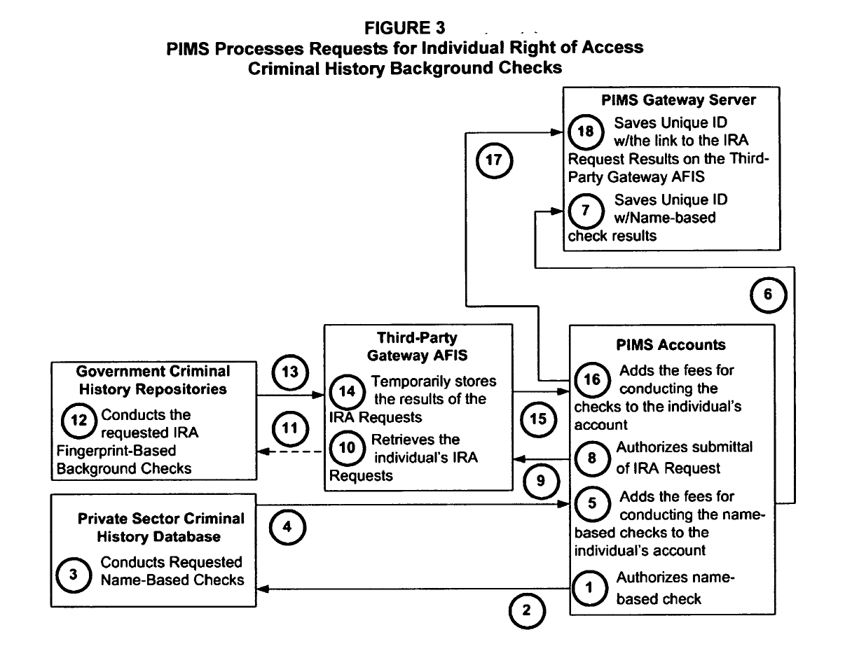

Referring now to FIG. 3, a third primary process of the subject invention is illustrated in diagrammatic form, namely the PIMS processes requests for Individual Right of Access criminal history background checks. When the individuals' PIDA accounts are configured, their fingerprints are taken and Individual Right of Access (IRA) requests are completed so their criminal history background checks can be. obtained from various criminal history repositories. The prints and IRA requests are submitted to a Third-Party Fingerprint Repository's Gateway Automated Fingerprint Identification System (AFIS), pending completion of the configuration process.

Upon completion of the account configuration process the PIMS Account server authorizes submission of the individuals IRA requests to the applicable state and federal criminal history repositories for fingerprint-based checks. In a preferred embodiment, the PIMS coordinates all submissions of requests for authenticated PID on behalf of the individuals, so they only have one organization to pay for all of the services they receive. However, the subject invention also includes implementations in which the individuals pay the individual providers directly. The PIMS Gateway Server also submits the individuals' IRAs to one or more private sector criminal history databases for name-based checks. The results of these criminal history checks are temporarily retained by the applicable Gateway Servers under normal security procedures. For the purpose of more fully describing the steps which comprise the third primary process, reference is now made to Table 3, below, where each enumerated step corresponds with the inscribed reference numerals of FIG. 3.

TABLE 3

| | |
|---|---|
| (1) | The PIMS assembles the individual's requests for Private Sector Criminal History |
| | Database IRA name-based check(s). |
| (2) | The PIMS submits the individual's requests for IRA name-based check(s) to the Private |
| | Sector Criminal History Databases. |
| (3) | The Private Sector Criminal History Database(s) perform the requested name-based |
| | checks. |
| (4) | The Private Sector Criminal History Database(s) return the results of the requested |
| | name-based checks to the PIMS Accounts. |
| (5) | The PIMS Accounts Server adds the fees for conducting the name-based checks to the |
| | individual's account. |
| (6) | The PIMS Accounts Server forwards the results of the name-based check to the PIMS |
| | Gateway Server. |
| (7) | The PIMS Gateway Server saves the Unique ID with name-based check results. |
| (8) | The PIMS Accounts Server authorizes submittal of the IRA Request. |
| (9) | The PIMS Accounts Server forwards the individual's IRA Request to the Third-Party |
| | Gateway AFIS. |
| (10) | The Third-Party Gateway AFIS retrieves the IRA Requests. |
| (11) | The Third-Party Gateway AFIS forwards the IRA Requests to the applicable |
| | Government Criminal History Repositories. |
| (12) | The Government Criminal History Repositories conducts the requested IRA fingerprint- |
| | based background checks. |
| (13) | The Government Criminal History Repositories forwards the results to the Third-Party |
| | Gateway AFIS. |
| (14) | The Third-Party Gateway AFIS temporarily stores the results of the IRA Requests. |
| (15) | The Third-Party Gateway AFIS reports receipt of the results of the IRA Requests to the |
| | PIMS Accounts Server. |
| (16) | The PIMS Accounts Server adds the fees for conducting the checks to the individual's |
| | account. |
| (17) | The PIMS Accounts Server forwards the link to the results of the IRA Requests to PIMS |
| | Gateway Server. |
| (18) | The PIMS Gateway Server stores the link to the results of the IRA Requests on the |
| | Third-Party Gateway AFIS. |

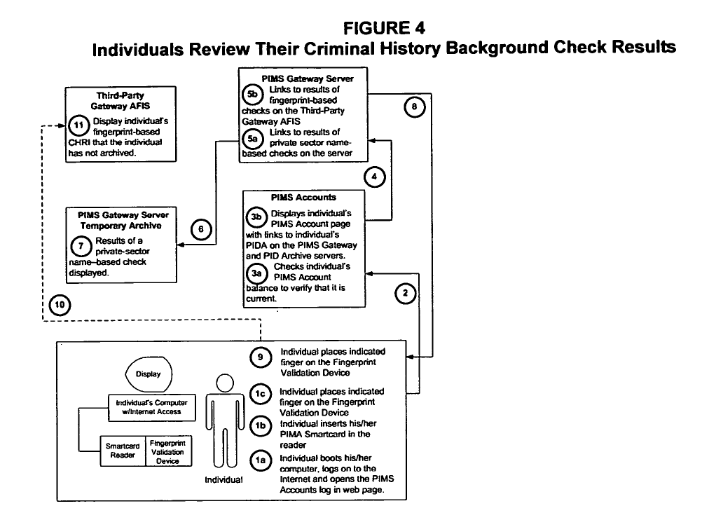

Referring now to FIG. 4, a fourth primary process of the subject invention is illustrated in diagrammatic form, namely the individuals review their criminal history background check results. Individuals are able to view the results of the fingerprint-based background check results stored on the Third-Party Gateway AFIS Server and the PIMS Gateway Server to ensure that the results are complete and accurate. Third-Party AFIS and PIMS support personnel are able to access the results on the Gateway servers when necessary to assist the individuals' in resolving any issues or questions regarding background checks and their results. For the purpose of more fully describing the steps which comprise the fourth primary process, reference is now made to Table 4, below, where each enumerated step corresponds with the inscribed reference numerals of FIG. 4.

TABLE 4

| | |
|---|---|
| (1a) | The individual boots his/her computer, logs on to the Internet and opens the PIMS |
| | Accounts log in web page. |
| (1b) | The individual inserts his/her PIMA Smartcard in the reader. |
| (1c) | The individual places the indicated finger on the Fingerprint Validation Device, which |
| | reads the individual's Unique ID stored on the Smart Card. |
| (2) | The Fingerprint Validation Device forwards the individual's Unique ID with |
| | authentication to the PIMS Accounts Server. |
| (3a) | The PIMS Accounts Server verifies that the individual's PIMS Account balance is |
| | current. |
| (3b) | The PIMS Accounts Server displays links to the individual's PIDA on the PIMS |
| | Gateway and PID Archive Servers. |
| (4) | The PIMS Accounts Server transmits the individual's Unique ID and authentication to |
| | the PIMS Gateway Server. |
| (5a) | The PIMS Gateway Server displays available links to results of private sector name- |
| | based checks on the server. |
| (5b) | The PIMS Gateway Server displays available links to results of fingerprint-based |
| | checks on the Third-Party Gateway AFIS. |
| (6) | The PIMS Gateway Server uses the individual's Unique ID to retrieve the selected |
| | private sector name-based check results. |
| (7) | The PIMS Gateway Server displays the requested private sector name-based check |
| | results. |
| (8) | The PIMS Gateway Server requests the individual to place the indicated finger on the |
| | Fingerprint Validation Device so it can send the Third-Party Gateway AFIS a |
| | validation print to ensure that the individual authorized access to the individual's |
| | CHRI. |
| (9) | The individual places the indicated finger on the Fingerprint Validation Device, which |
| | captures the print. |
| (10) | The Fingerprint Validation Device transmits the individual's fingerprint and Unique ID |
| | to the Third-Party AFIS. |
| (11) | The Third-Party AFIS validates that the individual's fingerprints were used to conduct |
| | the check and displays the CHRI. |

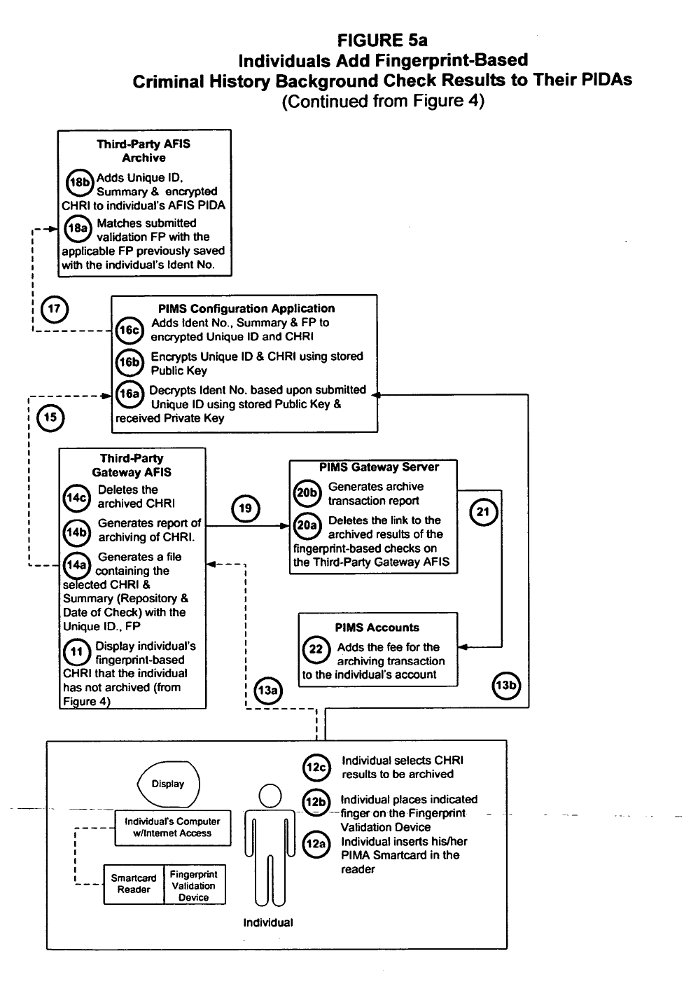

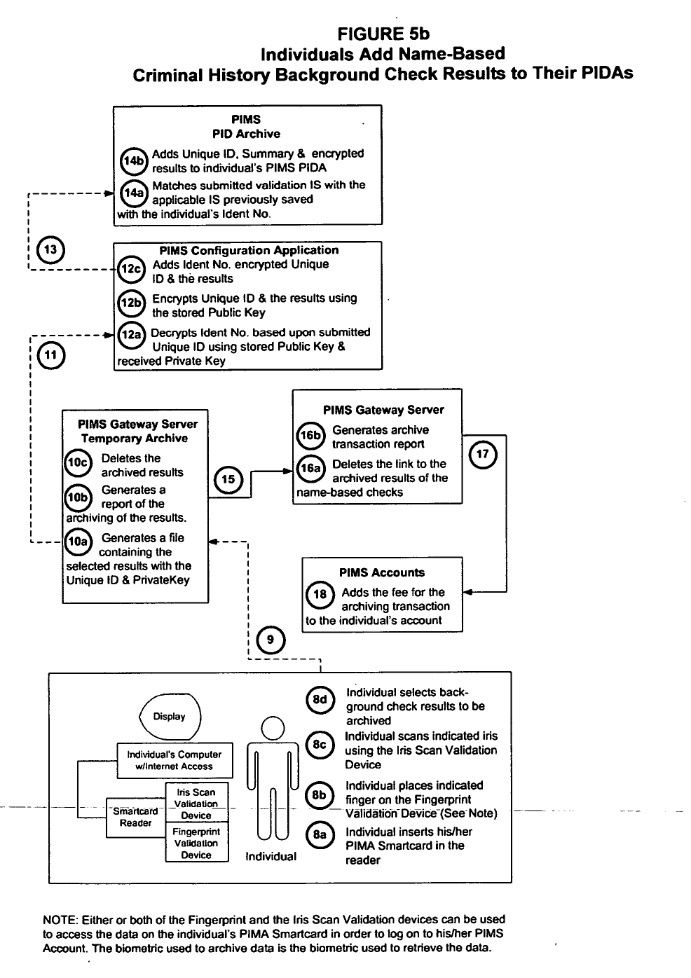

Referring now to FIGS. 5a and 5b, a fifth primary process of the subject invention is illustrated in diagrammatic form, namely individuals add criminal history background checks results to their PIDAs. Referring first to FIG. 5a, when the individuals are satisfied that the results of a fingerprint-based criminal history background check are accurate and complete, they are able to transfer the fingerprints used for the check and the results to their PIDA on the Third-Party AFIS Archive server. At completion of the transfer their fingerprints and the results are deleted from the Third-Party Gateway AFIS Server. Because there is no unencrypted link between the fingerprints retained in the Archive and the individuals' identity, these fingerprints cannot be used for any purposes not authorized by the individuals.

As shown in FIG. 5b, a similar process is used to archive the results of the name-based checks of private sector criminal history databases. The primary difference in archiving name-based checks versus fingerprint-based checks in a preferred embodiment is the location of the archive and the type of biometric used to authenticate access and retrieval of the PID, namely on the PIMS Archive Server using Iris Scans for authentication instead of the Third-Party AFIS Server using fingerprints for authentication. It should, however, be understood that the subject invention also contemplates a system in which all PID is saved on an AFIS Server with fingerprints authentication. For the purpose of more fully describing the steps which comprise the fifth primary process, reference is now made to Tables 5A and 5B, below, where each enumerated step corresponds with the inscribed reference numerals of FIGS. 5A and 5B.

TABLE 5A

| | |
|---|---|
| (12a) | The individual inserts his/her PIMA Smartcard in the reader. |
| (12b) | The individual places the indicated finger on the Fingerprint Validation Device, which |
| | reads the individual's Unique ID stored on the Smart Card. |
| (12c) | The individual selects the CHRI results to be archived. |
| (13a) | The Fingerprint Validation Device transmits the individual's Unique ID & FP to the |
| | Third-Party Gateway AFIS. |
| (13b) | The Fingerprint Validation Device transmits the individual's Unique ID & private key to |
| | the PIMS Configuration Server. |
| (14a) | The Third-Party Gateway AFIS generates a file containing the selected CHRI and |
| | Summary (the repository and the date of the check) with the Unique ID & FP. |
| (14b) | The Third-Party Gateway AFIS generates a report of the archiving of the selected |
| | CHRI. |
| (14c) | The Third-Party Gateway Server deletes the CHRI and the individual's fingerprints, |
| | after forwarding the file to the PIMS Configuration Application. |
| (15) | The Third-Party Gateway AFIS forwards the file containing the selected CHRI to the |
| | PIMS Configuration Server. |
| (16a) | The PIMS Configuration Server uses the private key received from the Fingerprint |
| | Validation Device and the public key it retrieves with the unique ID |
| (16b) | The PIMS Configuration Application encrypts the Unique ID and CHRI with the public |
| | key. |
| (16c) | The PIMS Configuration Application adds the Ident No., Summary & FP to the |
| | encrypted Unique ID & CHRI. |
| (17) | The PIMS Configuration Application forwards the Ident No., FP, Summary, encrypted |
| | CHRI & DD to the Third-Party AFIS Archive. |
| (18a) | The Third-Party AFIS Archive matches the submitted validation FP with the FP |
| | previously saved with the individual's Ident. No. |
| (18b) | The Third-Party AFIS Archive adds the Unique ID, Summary & encrypted CHRI to the |
| | individual's AFIS PIDA. |
| (19) | The Third-Party Gateway AFIS forwards the report of the archiving of the selected |
| | CHRI to the PIMS Gateway Server. |
| (20a) | The PIMS Gateway Server deletes the link to the archived results of the fingerprint- |
| | based checks on the Third-Party Gateway AFIS. |
| (20b) | The PIMS Gateway Server generates the archive transaction report. |
| (21) | The PIMS Gateway Server forwards the archive transaction report to the PIMS |
| | Accounts Server. |
| (22) | The PIMS Accounts Server adds the fee for archiving the transaction to the |
| | individual's account. |

TABLE 5B

| | |
|---|---|
| (8a) | The individual inserts his/her PIMA Smartcard in the reader. |
| (8b) | The individual places the indicated finger on the Fingerprint Validation Device, which |
| | reads the individual's Unique ID stored on the Smart Card. |
| (8c) | The individual scans the indicated iris using the Iris Scan Validation Device. |
| (8d) | The individual selects the name-based background check results to be archived. |
| (9) | The Iris Scan Validation Device transmits the individual's Unique ID, Private Key & IS |
| | to the PIMS Gateway Server Temporary Archive. |
| (10a) | The PIMS Gateway Server Temporary Archive generates a file containing the |
| | selected results with the Unique ID & Private Key. |
| (10b) | The PIMS Gateway Server Temporary Archive generates a report of the archiving of |
| | the results. |
| (10c) | The PIMS Gateway Server Temporary Archive deletes the archived results. |
| (11) | The PIMS Gateway Server Temporary Archive forwards Unique ID, Private Key, |
| | summary, selected results of name-based check to the PIMS Configuration |
| | Application. |
| (12a) | The PIMS Configuration Application decrypts the Ident. No. based upon the submitted |
| | Unique ID using the stored Public Key and the received Private Key. |
| (12b) | The PIMS Configuration Application encrypts the Unique ID and the results using the |
| | stored Public Key. |
| (12c) | The PIMS Configuration Application adds the Ident. No. and IS to the encrypted |
| | Unique ID and results. |
| (13) | The PIMS Configuration Application forwards the Ident No., IS, the summary and |
| | encrypted selected results of name-based check to the PIMS PID Archive. |
| (14a) | The PIMS PID Archive matches the submitted validation IS with the applicable IS |
| | previously saved with the Individual's Ident No. |
| (14b) | The PIMS PID Archive adds the Unique ID, Summary & encrypted results to the |
| | individual's PIMS PIDA. |
| (15) | The PIMS Gateway Server Temporary Archive forwards the report of the archiving to |
| | the PIMS Gateway Server. |
| (16a) | The PIMS Gateway Server deletes the link to the archived results of the name-based |
| | checks. |
| (16b) | The PIMS Gateway Server generates the archive transaction report. |
| (17) | The PIMS Gateway Server forwards the archive transaction report to the PIMS |
| | Accounts server. |
| (18) | The PIMS Accounts Server adds the fee for archiving the transaction to the |
| | individual's account. |

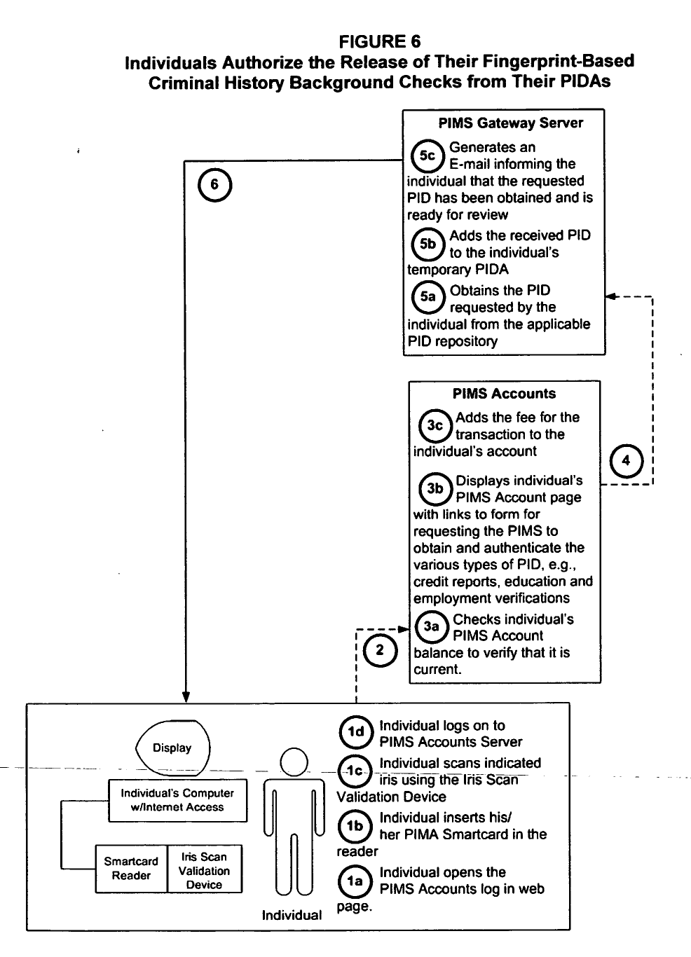

Referring now to FIG. 6, a sixth primary process of the subject invention is illustrated in diagrammatic form, namely individuals authorizing the release of their criminal history background checks from their PIDAs. The individuals' fingerprints permit access to the private keys stored on their Smartcards to gain access to the encrypted Criminal History Record Information (“CHRI”) from their PIDA. The PIMS Configuration Application decrypts the CHRI using the public key, generates an End-User No. and new public and private keys for the intended recipient of the CHRI. It then encrypts the CHRI using the intended recipient's public key and sends the intended recipient the private key, with instructions on how to access and decrypt the individual's CHRI on the Third-Party Gateway AFIS Server. The individual provides the intended End-User with the End-User No, which is needed to access the End-Users temporary account on the Third-Party Gateway AFIS Server. In this manner, no single communication contains all of the information required to access the individual's CHRI, which provides increased assurance that only the intended recipient will have access to the CHRI. For the purpose of more fully describing the steps which comprise the sixth primary process, reference is now made to Table 6, below, where each enumerated step corresponds with the inscribed reference numerals of FIG. 6.

TABLE 6

| | |
|---|---|
| (1a) | The individual inserts his/her PIMA Smartcard in the reader. |
| (1b) | The individual places the indicated finger on the Fingerprint Validation Device, which |
| | reads the individual's Unique ID stored on the Smart Card. |
| (1c) | The individual logs on to the PIMS Accounts Server. |
| (2) | The Fingerprint Validation Device forwards the individual's Unique ID with |
| | authentication to the PIMS Accounts Server. |
| (3a) | The PIMS Accounts Server verifies that the individual's PIMS Account balance is |
| | current. |
| (3b) | The PIMS Accounts Server displays links to the individual's PIMS Account page with |
| | links to the form for releasing their CHRI to an End-User. |
| (3c) | The individual enters the name and E-mail address of the organization/individual that |
| | is to receive his/her CHRI. |
| (3d) | The PIMS Accounts Server adds the fees for releasing their CHRI to the End-User to |
| | the individual's account. |
| (4) | The PIMS Accounts Server transmits the individual's Unique ID, FP and |
| | authentication to the PIMS Configuration Application Server. |
| (5a) | The PIMS Configuration Application retrieves the individual's encrypted Ident. No. |
| | using the submitted Unique ID and decrypts the Ident. No. using the received private |
| | key and stored public key. |
| (5b) | The PIMS Configuration Application generates a request for the individual's encrypted |
| | CHRI based upon the Ident. No. and the submitted FP. |
| (5c) | The PIMS Configuration Application generates a unique End-User No. and public and |
| | private keys for the End-User. |
| (6) | The PIMS Configuration Application submits the request to the Third-Party AFIS |
| | Archive for the individual's encrypted CHRI based upon the Ident. No. and the |
| | submitted FP |
| (7a) | The Third-Party AFIS Archive matches the submitted validation FP with the applicable |
| | FP previously saved with the individual's Ident. No. |
| (7b) | The Third-Party AFIS Archive creates a file of the individual's encrypted CHRI, |
| | identified with the submitted Unique ID and FP. |
| (8) | The Third-Party AFIS Archive submits to the PIMS Configuration Application the file |
| | with the individual's encrypted CHRI, identified with the submitted Unique ID and FP. |
| (9a) | The PIMS Configuration Application decrypts the individual's CHRI using the stored |
| | public key and the submitted private key. |
| (9b) | The PIMS Configuration Application encrypts the individual's CHRI using the End- |
| | User's public key. |
| (9c) | The PIMS Configuration Application creates a file of the individual's encrypted CHRI, |
| | identified with the submitted Unique ID and FP, along with the End-User ID and public |
| | key. |
| (9d) | The PIMS Configuration Application sends an E-mail to the End-User with its Private |
| | Key and instructions for accessing the individual's CHRI on the Third-Party Gateway |
| | AFIS. |
| (9e) | The PIMS Configuration Application generates instructions for the individual to provide |
| | the End-User ID to the End-User. |
| (10) | The PIMS Configuration Application submits to the Third-Party Gateway AFIS the file |
| | that includes the individual's encrypted CHRI, identified with the submitted Unique ID |
| | and FP, along with the End-User ID and public key. |
| (11) | The Third-Party Gateway AFIS saves the file that includes the individual's encrypted |
| | CHRI, identified with the submitted Unique ID and FP, along with the End-User ID and |
| | public key. |
| (12) | The PIMS Configuration Application returns the End-User ID to the individual with |
| | instructions to provide it to the End-User. |

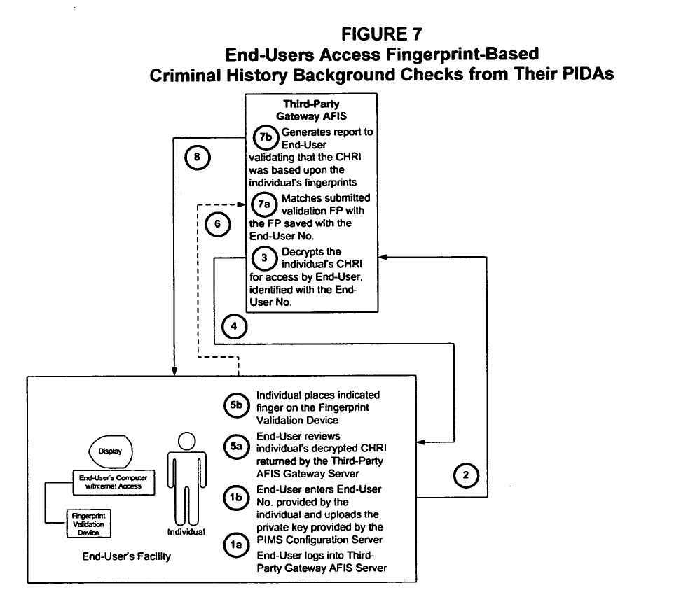

Referring now to FIG. 7, a seventh primary process of the subject invention is illustrated in diagrammatic form, namely End-Users access background check results. End-Users access the encrypted information on the Third-Party Gateway AFIS, which is then decrypted by the PIMS Configuration Server using the private key and their End-User No. Only when the intended End-User is actually viewing the information, is it in readable form. After the intended use of the access has been served, the encrypted information saved for the intended End-User is deleted, either after it has been viewed a defined number of times or after a defined period. The End-User is also able to validate that the CHRI was based upon intended individual's fingerprints by having the individual use the Fingerprint Validation device to submit a print to the Third-Party Gateway AFIS match with the saved prints. For the purpose of more fully describing the steps which comprise the seventh primary process, reference is now made to Table 7, below, where each enumerated step corresponds with the inscribed reference numerals of FIG. 7.

TABLE 7

| | |
|---|---|
| (1a) | The End-User logs on to Third-Party Gateway AFIS Server |
| (1b) | The End-User enters End-User No. provided to him/her by the individual, the Unique |
| | ID from the PIMS Configuration Server E-mail and attaches the private key included |
| | with that E-mail. |
| (2) | The End-User's computer sends the End-User No, Unique ID and private key to the |
| | Third-Party Gateway AFIS Server. |
| (3) | The Third-Party Gateway AFIS decrypts the CHRI authorized by the individual to be |
| | released to the End-User using the private key submitted by the End-User and the |
| | public key saved with the encrypted CHRI. |
| (4) | The Third-Party Gateway AFIS returns the decrypted CHRI that was authorized by the |
| | individual to be released to the End-User. |
| (5a) | The End-User reviews the CHRI that was authorized by the individual to be released |
| | to it. |
| (5b) | The individual places the indicated finger on the End-User's Fingerprint Validation |
| | Device. |
| (6) | The Fingerprint Validation Device submits the FP and the individual's Unique ID to the |
| | Third-Party Gateway AFIS. |
| (7a) | The Third-Party Gateway AFIS matches the submitted validation FP with the FP |
| | saved with the End-User No. |
| (7b) | The Third-Party Gateway AFIS generates a report to the End-User validating that the |
| | CHRI was based upon the individual's FP. |
| (8) | The Third-Party Gateway AFIS submits the report to the End-User validating that the |
| | CHRI was based upon the individual's FP. |

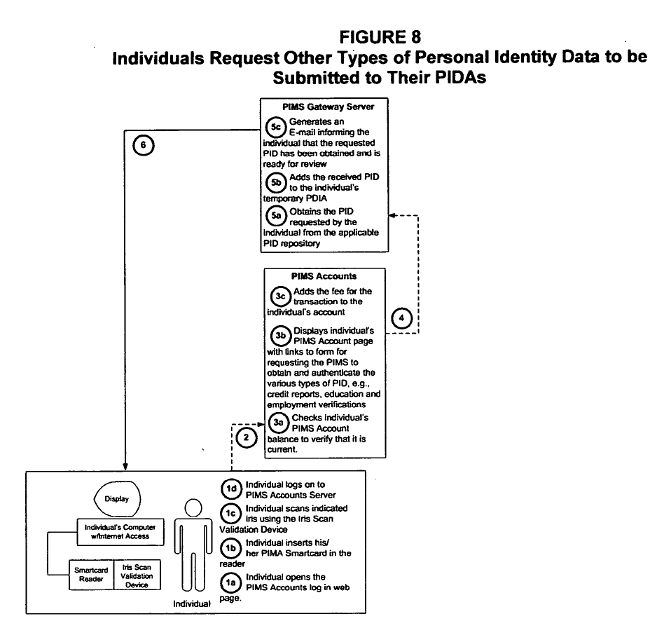

Referring now to FIG. 8, an eighth primary process of the subject invention is illustrated in diagrammatic form, namely individuals requesting other types of Personal Identity Data to be submitted to their PIDAs. Most PID is not linked to individuals' fingerprints. For example, historically, individuals' fingerprints have not been taken and retained when they applied for credit, employment or to be students at institutions of higher learning. As a result the individual's signature may be the only evidence unique to the individuals that links them to these records. Although fingerprints are the only recognized means of identifying individuals in state and federal criminal history repositories, other types of biometrics can be used by individuals to: (1) acknowledge the accuracy and completeness of PID provided various authentication agencies, for example, credit bureaus, employers and schools, and (2) control access to this information. In a preferred embodiment, Iris Scan (IS) technology is used since it is non-invasive, more unique than fingerprints and the required hardware is affordable for individuals and end-users of PID to add to their Internet-based computers. However, the subject invention further contemplates employment of other types of biometric technologies including fingerprints, facial and voice recognition, retina scans and hand geometry.

One of the services that the PIMS provides is compilation of the forms individuals must complete in order to obtain authenticated copies of individuals' PID from the official repositories of this information. Historically, such PID is returned directly to the individuals. However, since the individuals have had control over these documents, they are suspect in the eyes of the End-User organizations. When the PID is sent directly to the End-Users, the individuals do not have an opportunity to check it for completeness and accuracy prior to its use. With the invention, the individual has the opportunity to review the PID prior to releasing it to the End-User without ever having the ability to modify it. Instead the PIMS assists the individuals in having incomplete and inaccurate PID corrected by the originating authority. Only when the corrected PID is received from the originating authorities, do the individuals archive it and release it for use by End-Users. Since the individuals have never had the ability to alter the PID the End-Users receive from the system, they have assurance of its authenticity. When the PID is not available electronically, the system accepts and stores fax or electronically scanned hard copy documents. For the purpose of more fully describing the steps which comprise the eighth primary process, reference is now made to Table 8, below, where each enumerated step corresponds with the inscribed reference numerals of FIG. 8.

TABLE 8

| | |
|---|---|
| (1a) | The individual opens the PIMS Accounts log in web page. |
| (1b) | The individual inserts his/her PIMA Smartcard in the reader. |
| (1c) | The individual scans the indicated iris using the Iris Scan Validation Device. |
| (1d) | The individual logs on to the PIMS Accounts Server. |
| (2) | The Iris Scan Validation Device submits the individual's Unique ID and IS to the PIMS |
| | Accounts Server. |
| (3a) | The PIMS Accounts Server checks the individual's PIMS Account balance to verify |
| | that it is current. |
| (3b) | The PIMS Accounts Server displays the individual's PIMS Account page with links to |
| | the form for requesting the PIMS to obtain and authenticate the desired type of PID, |
| | e.g., credit reports, education and employment verifications, etc. |
| (3c) | The PIMS Accounts Server adds the fee for the transaction to the individual's account. |
| (4) | The PIMS Accounts Server submits the individual's request to obtain the selected |
| | PID. |
| (5a) | The PIMS Gateway Server obtains the PID requested by the individual from the |
| | applicable PID repository. |
| (5b) | The PIMS Gateway Server adds the PID to the individual's temporary PIDA on the |
| | server as it is received. |
| (5c) | The PIMS Gateway Server generates an E-mail informing the individual that the |
| | requested PID has been obtained and is ready for review. |
| (6) | The PIMS Gateway Server sends the E-mail informing the individual that the |
| | requested PID has been obtained and is ready for review. |

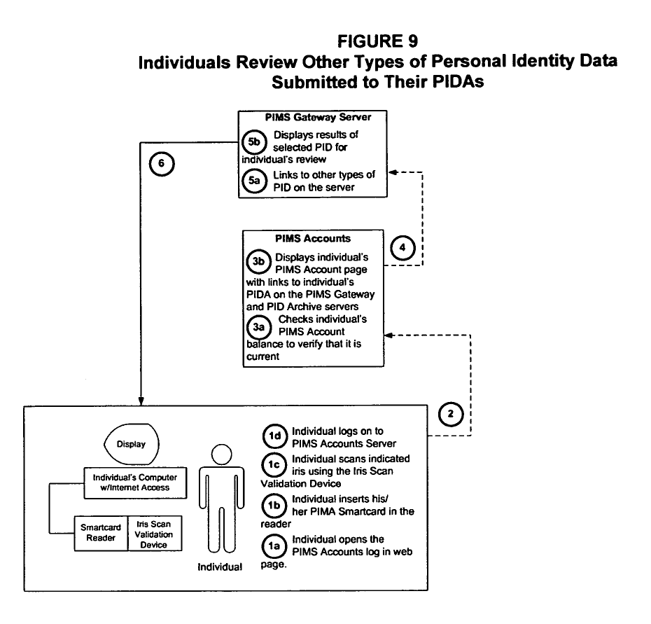

Referring now to FIG. 9, a ninth primary process of the subject invention is illustrated in diagrammatic form, namely individuals reviewing other types of personal identity data submitted to their PIDAs. The spread of identity theft makes it important for individuals to verify the accuracy and completeness of the personal identity information that organizations use to make decisions about individuals' suitability to serve in a variety of roles. Getting erroneous and incomplete personal identity information corrected at the repositories can be a daunting task for many. The PIMS can assist individuals in identifying the agencies that need to be contacted and the processes that must be followed to make the necessary corrections to their PID. After the corrections have been made, the corrected PID is resubmitted to the PIMS Gateway Server in the usual manner. For the purpose of more fully describing the steps which comprise the ninth primary process, reference is now made to Table 9, below, where each enumerated step corresponds with the inscribed reference numerals of FIG. 9.

TABLE 9

| | |
|---|---|
| (1a) | The individual opens the PIMS Accounts log in web page. |
| (1b) | The individual inserts his/her PIMA Smartcard in the reader. |
| (1c) | The individual scans the indicated iris using the Iris Scan Validation Device. |
| (1d) | The individual logs on to the PIMS Accounts Server. |
| (2) | The Iris Scan Validation Device submits the individual's Unique ID and IS to the PIMS |
| | Accounts Server. |
| (3a) | The PIMS Accounts Server checks the individual's PIMS Account balance to verify |
| | that it is current. |
| (3b) | The PIMS Accounts Server displays the individual's PIMS Account page with links to |
| | the individual's PIDA on the PIMS Gateway and PID Archive Servers. |
| (4) | The PIMS Accounts Server requests the PIMS Gateway Server to display the links to |
| | the other types of PID on the server that is awaiting the individual's review. |
| (5a) | The PIMS Gateway Server displays the links to the other types of PID on the server |
| | that is awaiting the individual's review. |
| (5b) | The PIMS Gateway Server displays the results of the selected PID for the individual's |
| | review. |
| (6) | The PIMS Gateway Server returns a copy of the results of the selected PID for the |
| | individual's review. |

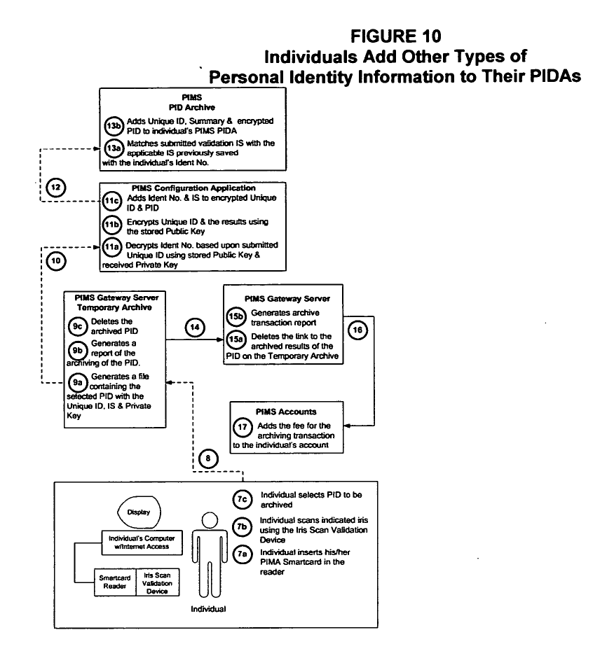

Referring now to FIG. 10, a tenth primary process of the subject invention is illustrated in diagrammatic form, namely individuals add other types of personal identity information to their PIDAs. The process by which individuals' add PID to their PIMS Archive is very similar to the process by which they added CHRI to the Third-Party AFIS. A different type of biometric is used to control access to the Archive. For the purpose of more fully describing the steps which comprise the tenth primary process, reference is now made to Table 10, below, where each enumerated step corresponds with the inscribed reference numerals of FIG. 10.

TABLE 10

| | |
|---|---|
| (7a) | The individual inserts his/her PIMA Smartcard in the reader. |
| (7b) | The individual scans the indicated iris using the Iris Scan Validation Device. |
| (7c) | The individual selects the PID to be archived. |
| (8) | The Iris Scan Validation Device submits the request with the IS, Unique ID and private |
| | key to the PIMS Gateway Server. |
| (9a) | The PIMS Gateway Server Temporary Archive generates a file containing the |
| | selected PID, the Unique ID, the IS and the private key. |
| (9b) | The PIMS Gateway Server Temporary Archive generates a report of the archiving of |
| | the PID. |
| (9c) | The PIMS Gateway Server Temporary Archive deletes the archived PID. |
| (10) | The PIMS Gateway Server Temporary Archive sends the PIMS Configuration Server |
| | the file containing the selected PID, the Unique ID, the IS and the private key. |
| (11a) | The PIMS Configuration Server retrieves the individual's public key with the Unique ID |
| | and then decrypts the individual's Ident No. with it and the submitted private key. |
| (11b) | The PIMS Configuration Server encrypts the Unique ID and the submitted PID using |
| | the stored public key. |
| (11c) | The PIMS Configuration Server creates a file with the Ident No. and IS to the |
| | encrypted Unique ID and PID. |
| (12) | The PIMS Configuration Server sends the PIMS PID Archive Server the file with the |
| | Ident No. and IS to the encrypted Unique ID and PID. |
| (13a) | The PIMS PID Archive Server matches the submitted validation IS with the IS |
| | previously saved with the Ident No. |
| (13b) | The PIMS PID Archive Server adds the encrypted Unique ID and PID to the |
| | individual's PIMS PIDA. |
| (14) | The PIMS Gateway Server Temporary Archive sends the report of the archiving of the |
| | PID to the PIMS Gateway Server. |
| (15a) | The PIMS Gateway Server deletes the link to the archived results in the PIMS |
| | Gateway Temporary Archive. |
| (15b) | The PIMS Gateway Server generates an archive transaction report |
| (16) | The PIMS Gateway Server sends the archive transaction report to the PIMS Account |
| | Server. |
| (17) | The PIMS Account Server adds the fee for the archiving transaction to the individual's |
| | account. |

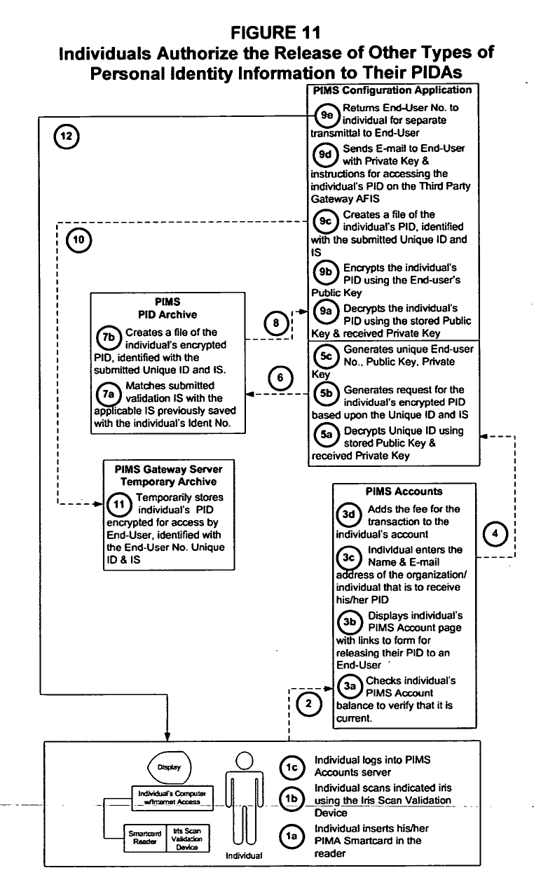

Referring now to FIG. 11, an eleventh primary process of the subject invention is illustrated in diagrammatic form, namely individuals authorizing the release of other types of their personal identity data in their PIDAs. The process by which individuals authorize the release of other types of PID is the same as the processes for authorizing release of fingerprint based CHRI. For the purpose of more fully describing the steps which comprise the eleventh primary process, reference is now made to Table 11, below, where each enumerated step corresponds with the inscribed reference numerals of FIG. 11.

TABLE 11

| | |
|---|---|
| (1a) | The individual inserts his/her PIMA Smartcard in the reader. |
| (1b) | The individual scans the indicated iris using the Iris Scan Validation Device. |
| (1c) | The individual opens the PIMS Accounts log in web page. |
| (2) | The Iris Scan Validation Device submits the individual's Unique ID and IS to the PIMS |
| | Accounts Server. |
| (3a) | The PIMS Accounts Server checks the individual's PIMS Account balance to verify |
| | that it is current. |
| (3b) | The PIMS Accounts Server displays links to the individual's PIMS Account page with |
| | links to the form for releasing their PID to an End-User. |
| (3c) | The individual enters the name and E-mail address of the organization/individual that |
| | is to receive his/her PID. |
| (3d) | The PIMS Accounts Server adds the fees for releasing their PID to the End-User to |
| | the individual's account. |
| (4) | The PIMS Accounts Server transmits the individual's Unique ID, IS and authentication |
| | to the PIMS Configuration Application Server. |
| (5a) | The PIMS Configuration Application retrieves the individual's encrypted Ident. No. |
| | using the submitted Unique ID and decrypts the Ident. No. using the received private |
| | key and the stored public key. |
| (5b) | The PIMS Configuration Application generates a request for the individual's encrypted |
| | PID based upon the Ident. No. and the submitted IS. |
| (5c) | The PIMS Configuration Application generates a unique End-User No. and public and |
| | private keys for the End-User. |
| (6) | The PIMS Configuration Application submits the request to the PIMS PID Archive for |
| | the individual's encrypted PID based upon the Ident. No. and the submitted IS. |
| (7a) | The PIMS PID Archive matches the submitted validation IS with the applicable IS |
| | previously saved with the individuals Ident. No. |
| (7b) | The PIMS PID Archive creates a file of the individual's encrypted PID, identified with |
| | the submitted Unique ID and IS. |
| (8) | The PIMS PID Archive submits to the PIMS Configuration Application the file with the |
| | individual's encrypted PID, identified with the submitted Unique ID and IS. |
| (9a) | The PIMS Configuration Application decrypts the individual's PID using the stored |
| | public key and the submitted private key. |
| (9b) | The PIMS Configuration Application encrypts the individual's PID using the End- |
| | User's public key. |
| (9c) | The PIMS Configuration Application creates a file of the individual's encrypted PID, |
| | identified with the submitted Unique ID and IS, along with the End-User ID and public |
| | key. |
| (9d) | The PIMS Configuration Application sends an E-mail to the End-User with its Private |
| | Key and instructions for accessing the individual's PID on the PIMS Gateway Server. |
| (9e) | The PIMS Configuration Application generates instructions for the individual to provide |
| | the End-User ID to the End-User. |
| (10) | The PIMS Configuration Application submits to the PIMS Gateway Server the file that |
| | includes the individual's encrypted PID, identified with the submitted Unique ID and |
| | IS, along with the End-User ID and public key. |
| (11) | The PIMS Gateway Server saves the file that includes the individual's encrypted PID, |
| | identified with the submitted Unique ID and IS, along with the End-User ID and public |
| | key. |
| (12) | The PIMS Configuration Application returns the End-User ID to the individual with |
| | instructions to provide it to the End-User. |

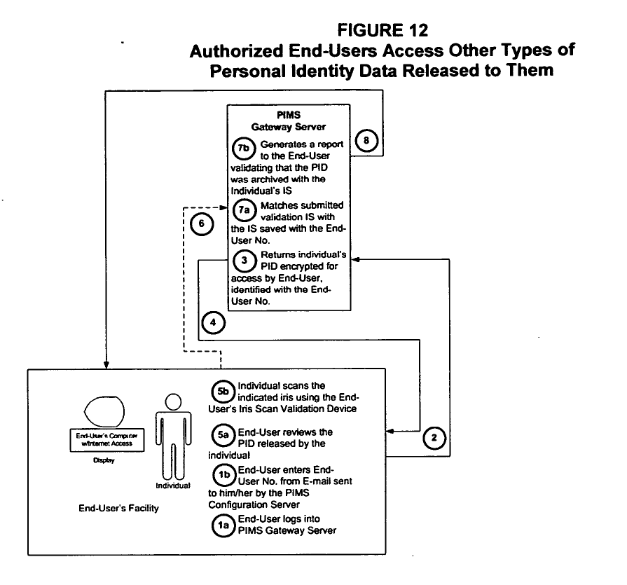

Referring now to FIG. 12, a twelfth primary process of the subject invention is illustrated in diagrammatic form, namely authorized end-users accessing other types of personal identity data. The process by which End-Users access other types of PID is the same as they use to access CHRI. For the purpose of more fully describing the steps which comprise the twelfth primary process, reference is now made to Table 12, below, where each enumerated step corresponds with the inscribed reference numerals of FIG. 12.

TABLE 12

| (1a) | The End-User logs on to PIMS Gateway Server. |
|---|---|
| (1b) | The End-User enters End-User No. provided to him/her by the individual, the Unique |
| | ID from the PIMS Configuration Server E-mail and attaches the private key included |
| | with that E-mail. |
| (2) | The End-User's computer sends the End-User No, Unique ID and private key to the |
| | PIMS Gateway Server. |
| (3) | The PIMS Gateway Server decrypts the PID authorized by the individual to be |
| | released to the End-User using the private key submitted by the End-User and the |
| | public key saved with the encrypted PID. |
| (4) | The PIMS Gateway Server returns the decrypted PID that was authorized by the |
| | individual to be released to the End-User. |
| (5a) | The End-User reviews the PID that was authorized by the individual to be released to |
| | it. |
| (5b) | The individual scans the indicated iris using the End-User's Iris Scan Validation |
| | Device. |
| (6) | The Iris Scan Validation Device submits the IS and the individual's Unique ID to the |
| | PIMS Gateway Server. |
| (7a) | The PIMS Gateway Server matches the submitted validation IS with the IS saved with |
| | the End-User No. |
| (7b) | The PIMS Gateway Server generates a report to the End-User validating that the PID |
| | was archived with the individual's IS. |
| (8) | The PIMS Gateway Server submits the report to the End-User validating that the PID |

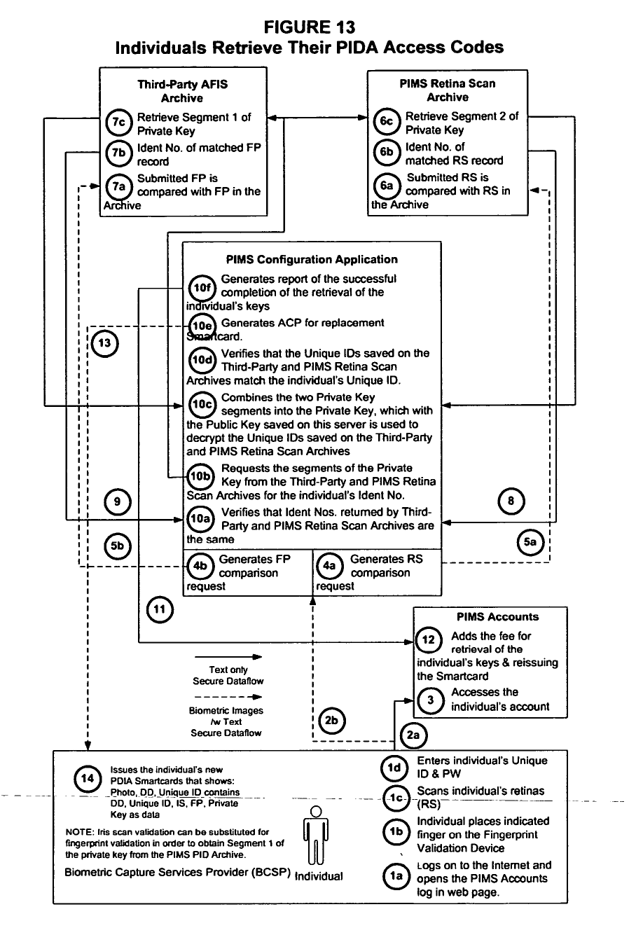

Referring now to FIG. 13, a thirteenth primary process of the subject invention is illustrated in diagrammatic form, namely individuals retrieving their PIDA access codes. In a preferred embodiment, the individual is issued two cards, one of which should be kept in a safe place, such as the individual's safety deposit box. This way, if one of the cards is lost or damaged, the backup card can be retrieved and used to create a replacement. However, in the event that both Smartcards are lost, with layered biometric validation, an individual can still retrieve the PIDA access codes needed to regenerate their Smart Cards, either with the same codes or with new codes, if there is reason to believe that the old Smartcards were compromised.

The services of a Biometric Capture Services Provider are required. In a preferred embodiment, Segment 1 of the individual's private key can be accessed by matching the individual's fingerprint or iris scan with these biometrics that were saved when the account was configured. Segment 2 can only be accessed by matching the individual's Retina Scan with the Retina Scan saved in the PIMS Retina Scan Archive when the account was configured. The sole purpose of this mechanism is to retain a copy of the other segment of the individual's private key. For the purpose of more fully describing the steps which comprise the thirteenth primary process, reference is now made to Table 13, below, where each enumerated step corresponds with the inscribed reference numerals of FIG. 13.

TABLE 13

| | |
|---|---|
| (1a) | The BCSP logs on to the Internet and opens the PIMS Accounts log in web page. |
| (1b) | The individual places the indicated finger on the Fingerprint Validation Device. |
| (1c) | The BCSP scans the individual's retinas. |
| (1d) | The individual enters his/her Unique ID and Password. |
| (2a) | The BCSP computer submits the individual's Unique ID and password to the PIMS |
| | Accounts Server. |
| (2b) | The Retina Scan and Fingerprint Validation Devices submit the individuals RS and FP |
| | to the PIMS Configuration Application. |
| (3) | The PIMS Accounts Server accesses the individual's PIMS Account. |
| (4a) | The PIMS Configuration Server generates an RS comparison request. |
| (4b) | The PIMS Configuration Server generates a FP comparison request. |
| (5a) | The PIMS Configuration Server submits the RS to the Retina Scan Archive for |
| | comparison. |
| (5b) | The PIMS Configuration Server submits the FP to the Third-Party AFIS Archive for |
| | comparison. |
| (6a) | The PIMS Retina Scan Archive Server compares the submitted RS with the other RS |
| | saved in the archive to find any that match. |
| (6b) | The PIMS Retina Scan Archive Server retrieves the Ident No. from the matched |
| | record where the RS match. |
| (6c) | The PIMS Retina Scan Archive Server retrieves the private key from the matched |
| | record where the RS match. |
| (7a) | The Third-Party AFIS Archive Server compares the submitted FP with the other FP |
| | saved in the archive to find any that match. |
| (7b) | The Third-Party AFIS Archive Server retrieves the Ident No. from the matched record |
| | where the FP match. |
| (7c) | The Third-Party AFIS Archive Server retrieves the private key from the matched |
| | record where the FP match. |
| (8) | The PIMS Retina Scan Archive submits Segment 2 of the private key to the PIMS |
| | Configuration Server. |
| (9) | The Third-Party AFIS Archive submits Segment 1 of the private key to the PIMS |
| | Configuration Server. |
| (10a) | The PIMS Configuration Server verifies that the Ident Nos. returned by the Third-Party |
| | AFIS and PIMS Retina Scan Archives are the same. |
| (10b) | The PIMS Configuration Server retrieves Segment 1 of the private key with the |
| | encrypted Unique ID from the Third-Party AFIS Archive Server and Segment 2 with |
| | the encrypted Unique ID from the PIMS Retina Scan Archive Server. |
| (10c) | The PIMS Configuration Server combines the two private key segments into the |
| | private key, which with the public key saved under the individual's Ident No. on this |
| | Server is used to decrypt the Unique Ids saved on the Third-Party and PIMS Retina |
| | Scan Archive Servers. |
| (10d) | The PIMS Configuration Server verifies that the Unique Ids saved on the Third-Party |
| | AFIS and PIMS Retina Scan Archives match the Unique ID that was submitted by the |
| | individual. |
| (10e) | The PIMS Configuration Server generates the ACP needed to create the replacement |
| | Smartcards. |
| (10f) | The PIMS Configuration Server generates a report of the successful completion of the |
| | retrieval of the individual's keys. |
| (11) | The PIMS Configuration Server submits the report of the successful completion of the |
| | retrieval of the individual's keys to the PIMS Accounts Server. |
| (12) | The PIMS Accounts Server adds the fee for retrieval of the individual's keys and |
| | reissuing the Smartcards to the individual's account. |
| (13) | The PIMS Configuration Server submits the ACP needed to create the replacement |
| | Smartcards to the BCSP. |
| (14) | The BCSP issues the individual's new PDIA Smartcards that shows the photo, DD, |
| | Unique ID and contains the DD, Unique ID, IS, FP and private key as data. |

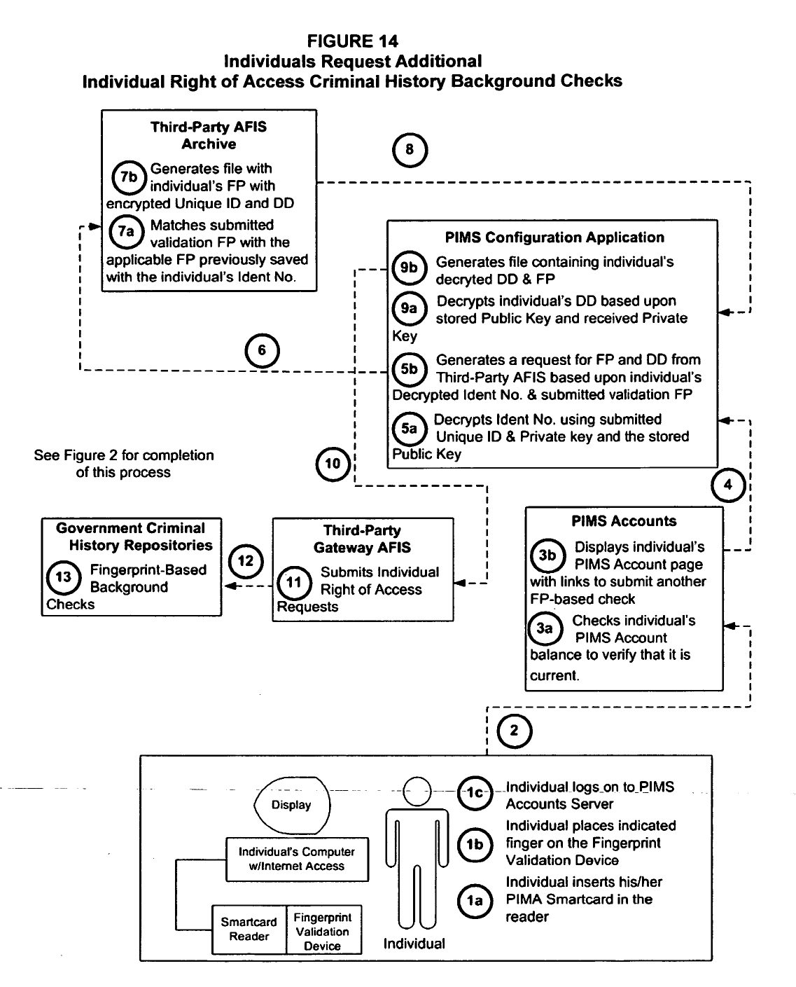

Referring now to FIG. 14, a fourteenth primary process of the subject invention is illustrated in diagrammatic form, namely individuals requesting additional Individual Right of Access criminal history background checks. An important benefit of the subject invention is the ability for individuals' to resubmit the fingerprints retained in their PIDAs for subsequent IRA criminal history background checks at government repositories. To do so, the individual uses processes similar to the ones that they use to release their CHRI for access by End-Users. By doing so, individuals' save the cost and inconvenience of going to a Biometric Capture Services Provider to have their fingerprints captured. For the purpose of more fully describing the steps which comprise the fourteenth primary process, reference is now made to Table 14, below, where each enumerated step corresponds with the inscribed reference numerals of FIG. 14.

TABLE 14

| | |
|---|---|
| (1a) | The individual inserts his/her PIMA Smartcard in the reader. |
| (1b) | The individual places the indicated finger on the Fingerprint Validation Device. |
| (1c) | The individual logs on to the PIMS Accounts Server. |
| (2) | The Fingerprint Validation Device forwards the individual's Unique ID with |
| | authentication to the PIMS Accounts Server. |
| (3a) | The PIMS Accounts Server checks the individuals PIMS Account balance to verify that |
| | it is current. |
| (3b) | The PIMS Accounts Server displays the individual's PIMS Account page with links to |
| | submit another FP-based check. |
| (4) | The PIMS Accounts Server submits the individual's request for another FP-based check |
| | to the PIMS Configuration Application. |
| (5a) | The PIMS Configuration Application decrypts the individual's Ident No. using the |
| | submitted Unique ID and private key and the stored public key. |
| (5b) | The PIMS Configuration Application generates a request for the individual's FP and DD |
| | from the Third-Party AFIS Archive with the individual's decrypted Ident No. and the |
| | submitted validation FP. |
| (6) | The PIMS Configuration Application submits the request for the individual's fingerprints |
| | and DD to the Third-Party AFIS Archive. |
| (7a) | The Third-Party AFIS Archive matches the submitted validation FP with the applicable |
| | FP saved with the individual's Ident No. |
| (7b) | The Third-Party AFIS Archive generates a file with the individual's FP with encrypted |
| | Unique ID and DD. |
| (8) | The Third-Party AFIS Archive submits the file with the individual's FP and encrypted |
| | Unique ID and DD to the PIMS Configuration Application. |
| (9a) | The PIMS Configuration Application decrypts the individual's Unique ID and DD using |
| | the submitted Unique ID and private key and the stored public key. |
| (9b) | The PIMS Configuration Application generates the file containing the individual's |
| | decrypted DD and FP. |
| (10) | The PIMS Configuration Application submits the file containing the individual's |
| | decrypted DD and FP to the Third-Party Gateway AFIS |
| (11) | The Third-Party Gateway AFIS completes the Individual Right of Access Request for |
| | the fingerprint-based check. |
| (12) | The Third-Party Gateway AFIS submits the Individual Right of Access Request to the |
| | applicable Government Criminal History Repositories |
| (13) | The applicable Government Criminal History Repositories conduct the requested |
| | fingerprint-based checks. |

Having fully described the subject systems, methods and apparatus which comprise the subject invention, it should be now readily appreciated that the heretofore described primary objectives of the invention are achieved. Specifically, individuals' archived fingerprints cannot be searched in conjunction with criminal justice investigations. This objective is met by saving the individuals' fingerprints in an AFIS Archive that does not include any direct links to the individuals' demographic data. Links to the individuals' demographic data require access to their private keys, which are maintained on Smartcards for their accounts.

Additionally, data repositories and personal identity management services can submit authenticated personal identity data confidentially and electronically to the individuals' PIDAs. This objective is met by using gateway servers that function as “lockboxes” to which the third-party sources submit PID, which cannot be altered, except by being superseded by the third-party sources. Conventional digital signature authentication is used to verify that data has not been altered during transmission.

Also, individuals can check their personal identity data, which is provided, gathered or authenticated by third-party sources (criminal history record repositories, credit bureaus, personal identity management systems, etc), for accuracy and completeness prior to authorizing the addition of the data to their personal identity data archives. This objective is met by permitting the individuals to view the PID and submit requests to the data sources to correct erroneous and incomplete data and supersede it with updated reports.

Further, no one, including the individuals, can alter authenticated personal identity data saved in individuals' personal archives, so the data will be credible to recipient organizations. This objective is met by: (1) limiting the individuals to read-only access to their data and (2) always storing the data in an encrypted format and using digital signature authentication to verify that the data has not been altered during storage or in decryption.

Moreover, individuals' personal identity data, including links between the individuals' identity data and their fingerprints, is maintained securely in their personal archives. This objective is met by using an intermediary “configuration” server that operates between the archive servers and the more accessible gateway servers. This configuration server retains the individual's public encryption key linked to the individual's public Unique Identifier and an encrypted private identifier (Ident No.) that is used to link the individual to his/her fingerprints and archived PID.

Still further, individuals' personal identity data can be disclosed only as authorized by the individuals to personally accountable representatives of intended recipient organizations and the data is communicated securely to the intended recipients. This objective is met when individual's transfer the encrypted PID they intend to release to a specific End-User from their secure Archive to the intermediary configuration server where it is decrypted and re-ncrypted using new public and private keys generated specifically for the End-User. Thus, only the End-User will be able to decrypt the PID.

Finally, individuals can retrieve their access codes, using two separate types of biometrics to authenticate their identity. These access codes cannot be retrieved in any other way, including by the system administrators. This objective is met by segregating the individual's private key and saving the segments on two separate servers with the only link with the individual through biometrics. Two separate biometrics (retina scans and either fingerprints or iris scans) are required to recover the private key segments. These public key segments cannot be retrieved without a biometric, since without the public and private key there is no link between the individual and the records that include these private key segments.

The described processes, apparatus and systems permit individuals to manage their personal identity data to establish their credentials and to help them protect their good names, including clearing them in the event of identity theft. All access to this personal identity data, including the biometrics that uniquely establish their identity, is under the personal control of the individuals, with access limited to others only with their specific authorization.

These objectives were accomplished through processes, apparatus and systems that include at least two separate archives that store encrypted data about individuals that can be accessed only via the individuals' biometrics specific to the archives and unique Identification Numbers. The Identification Numbers are encrypted when they are associated with the individuals' demographic data, which includes their names, Social Security Numbers and the Unique Identifiers assigned by the system to each of the individuals. Public/private key encryption is used to encrypt the Demographic Data and Personal Identity Data maintained in the archives and the Identification Numbers maintained in the PIMS Configuration Application server that links the rest of the system to the archives. To permit the private keys to be securely retained for use in regenerating the Smartcard in case of loss or damage, separate segments of the private key are stored on different servers each of which requires submittal of a different biometric, which has to match the biometric associated with the private key segment.

Although the present invention has been described with reference to the particular embodiments herein set forth, it is understood that the present disclosure has been made only by way of example and that numerous changes in details of construction may be resorted to without departing from the spirit and scope of the invention. Thus, the scope of the invention should not be limited by the foregoing specifications.

What is claimed as being new, useful and desired to be protected by Letters Patent of the United States is as follows:

1. A method of managing an individuals personal identity data, the method comprising the steps of: 1) sharing of public digital signature keys and hashing functions between a Personal Identity Management Service and a Personal Identity Data Repository whereby reports concerning an individual's personal identity information provided by said Repository to said Personal Identity Management Service may be authenticated and changes to said reports detected; 2) said individual establishing his own Personal Identity Data Archive by capturing his fingerprints, photograph and retinal scan at a Biometric Capture Services Provider and requesting an initial fingerprint-based criminal history background check be performed on said individual; 3) said Personal Identity Management Service processing said individual's request for a criminal history background check; 4) enabling said individual to review the results of said criminal history background check for accuracy and completeness and to correct erroneous and incomplete information; 5) enabling said individual to add criminal history background check results to said Personal Identity Data Archive; 6) enabling said individual to authorize the release of their criminal history background check results from their Personal Identity Data Archive to at least one end-user; 7) enabling said at least one end-user to access at least a portion of said background check results; and to validate that said at results were based upon the fingerprints of said individual by: (a) capturing validation fingerprints from the individual or (b) viewing the photograph taken when the fingerprints were captured; 8) enabling said individual to request said Personal Identity Management Service to submit additional personal identity data to said Personal Identity Data Archive and said Personal Identity Data Repository; 9) enabling said individual to review said additional personal identity data submitted to said Personal Identity Data Archive for accuracy and completeness and to correct erroneous and incomplete information; 10) enabling said individual to add additional personal identity data to said Personal Identity Data Archive; 11) enabling said individual to confirm that said additional personal identity data is complete and accurate and to authorize said Personal Identity Management Service to release at least a portion of said additional personal identity data in said Personal Identity Data Archive to at least one end-user; 12) permitting said at least one end-user access to said additional personal identity data released by said Personal Identity Management Service; 13) said individual retrieving their Personal Identity Data Archive access code based upon said Biometric Capture Service Provider's submittal of fingerprint and retinal scan confirmation of said individual's identity; and 14) enabling said individual to request additional criminal history background checks of state and FBI repositories and name-based checks of private sector criminal history databases.
